(19) United States
(12) Patent Application Publication
(10) Pub. No.: US 2009/0144151 A1
(43) Pub. Date: Jun. 4, 2009

(54) AUTOMATED RENTAL SYSTEM

(76) Inventor: Eric Pajot, Chenes-bougerie (CH)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/299,860

(22) PCT Filed: May 3, 2007
(86) PCT No.: PCT/IB2007/051659

§ 371 Date: Jan. 8, 2009

(30) Foreign Application Priority Data
May 11, 2006 (IB) PCT/IB2006/051478

(51) Int. Cl. G06Q 30/00; G06Q 50/00; H04M 11/08; H04M 15/38; G01C 21/00

(52) U.S. Cl. 705/14; 705/30; 701/300; 455/409; 455/407

(57) ABSTRACT

Automated rental system comprising: —an object for rent which is provided with an identification code, —an auxiliary element functionally associated with the object for rent and comprising a remotely activated activation/deactivation system, —a portable device, such as a mobile telephone, comprising a wireless telecommunication interface, —a central unit comprising means for bidirectional communication with said auxiliary element and said portable device; said central unit further comprising means for processing said identification code, means for acting on said activation/deactivation system, means for recording the duration of use of the object for rent, and means for managing the accounts of the persons using said object for rent.

### FIELD OF THE INVENTION

The present invention relates to the automated rental of objects whose operation requires the provision of an energy source, for example an electrical source.

It relates more specifically to the rental of such objects by means of a wireless portable communication device, for example a mobile telephone.

Various rental systems, in particular of vehicles, having some degree of automation are known. Such systems are described in patent documents FR-A-2 732 144, FR-A-2 744 543, EP-A-0 451 482, DE-A-42 27 969, DE-A-43 01 039, FR-A-2 656 450.

### GENERAL DESCRIPTION OF THE INVENTION

In the present text, the term “rentable object” should be taken very generally. It covers any material or immaterial thing able to be rented. By way of example, it is possible to cite a vehicle, a piece of apparatus (e.g. a washing machine), a safe, a hotel room, a solarium booth, an automatic locker in a public place (airport, station, etc.), a parking space, an electrical connection (e.g. for recharging the battery of a vehicle), a computer (e.g. in an Internet café), an advertising space, e.g. on the Internet, etc.

One of the objectives of the present invention consists in simplifying the current rental systems.

A second objective aims to profit from mobile telephones or other similar pieces of apparatus such as “smartphones” or pocket computers, particularly with regard to the messaging systems (e.g. SMS) associated with them.

A third objective aims to offer the possibility for the user to take and return the rentable object at any place at all, predefined or not, without having, for example, to bring it back to a given place after use.

The aforementioned objectives are attained thanks to the system according to the invention as described by the claims.

As it is concerned with the activation/deactivation of the system connected to the auxiliary element, it should be noted that in the context of the present invention there is no direct transmission of signals between the portable device and the rentable object and/or the auxiliary element, but always intermediate signal processing by the central facility.

Direct transmission may, however, be possible to carry out other actions.

This way of proceeding, which constitutes one of the fundamental features of the invention, offers many advantages, in particular that of improved checking by the central facility of the exploitation of the rentable object, thus reducing the risk of fraudulent use of the rentable objects. The invention furthermore enables the fixing of a more or less expensive and expansive interface (specific control panel, control buttons, etc.) on the rentable object to be eliminated.

As indicated above, the system according to the invention essentially comprises the four following elements:

a) a rentable object provided with an identification code, the latter able to be of any type (bar code, pictogram, number, name, etc.);
b) an auxiliary element operationally connected with the rentable object and comprising an activation/deactivation system that can be remotely activated;
c) a portable device, such as a mobile telephone, comprising a wireless telecommunications interface; and
d) a central facility comprising means to ensure two-way communication with said auxiliary element and said portable device.

The auxiliary element may be located on the rentable object, for example when it is a vehicle, or nearby, for example on the electrical cable that supplies power to the rentable object.

The central facility may be composed of one or more computer platforms, enabling in particular control of the following actions by means of a wireless communications device such as Wi-Fi, GSM, GPRS, EDGE or UMTS:
signal reception and transmission, e.g. in SMS, MMS, audio or video form, coming from/in the direction of the auxiliary element;
signal reception and transmission, e.g. in SMS, MMS, audio or video form, coming from/in the direction of the portable device;
identification of the auxiliary element and of the portable device, respectively, from their holder;
activation/deactivation of the auxiliary element by means of signals propagating via a wireless communications interface;
hosting and creation of personal user accounts comprising identification codes with bank or postal details, etc., with a view to debiting the accounts of users after use of the rentable objects;
options for payment in different ways (prepayment, direct debit, debit by telephone account, etc.);
reception of signals relating to geolocalization information, e.g. GPS information, from the auxiliary element and/or from the rentable object;
inquiring about and tracking states of the auxiliary element and/or of the rentable object (stand-by, active, deactivated, discharged, etc.); and
billing and debit confirmation, according to the chosen mode of payment, for accounting by the user.

### DETAILED DESCRIPTION OF THE INVENTION

The invention will be understood better hereafter by means of two examples illustrated by the following figures:

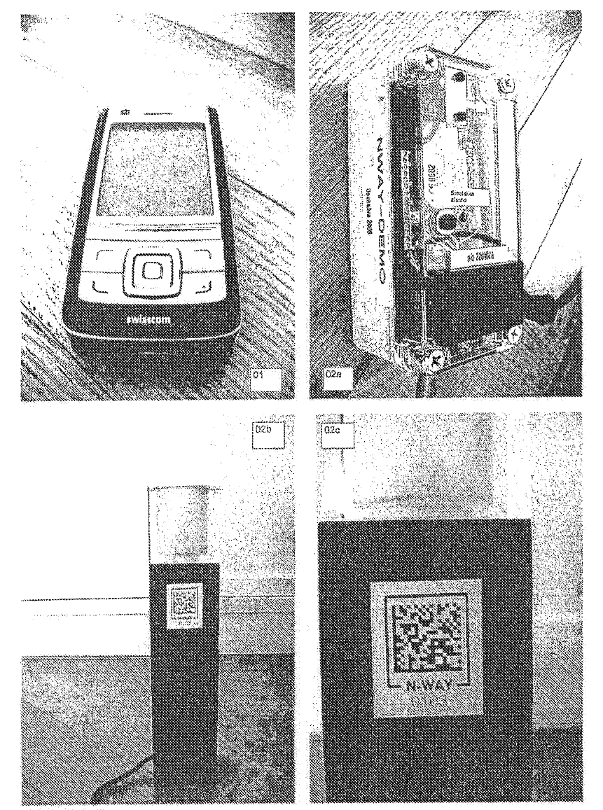

FIGS. 1 to 15 describe a first example in which the rentable object is an electric light.

FIG. 16 describes a second example in which the rentable object is a vehicle.

### EXAMPLE 1

### Rental of a Light

FIG. 01 illustrates a mobile telephone.

FIG. 02a shows an auxiliary element connected to the electrical network and in which the lamp socket is fixed.

FIG. 02b illustrates a light provided with an identification code.

FIG. 02c is an enlargement of the identification code, the latter in fact being presented in two ways, namely a pictogram intended to be input via a scanner and a number (0103) intended to be input manually on the mobile telephone keypad.

FIG. 03 illustrates the automated input of the identification code by means of a scanner integrated in the mobile telephone.

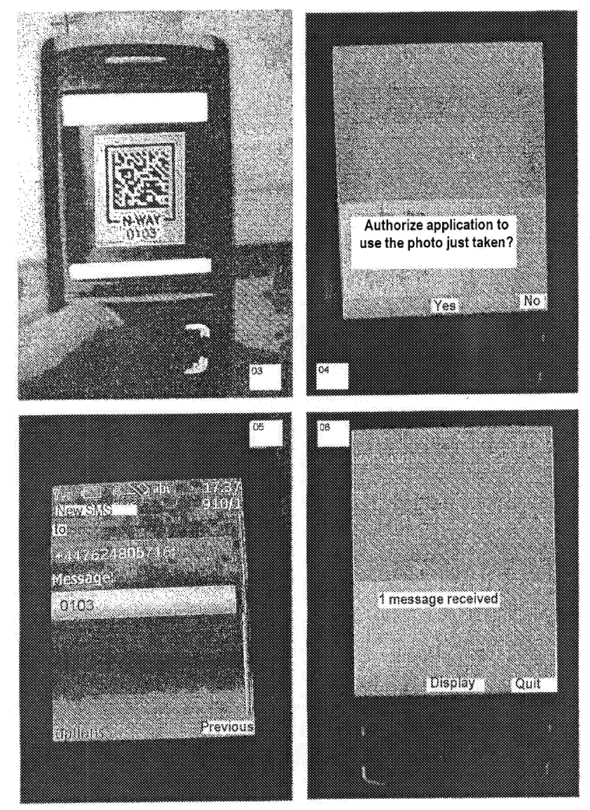

FIG. 04 shows a confirmation message confirming the identification code input automatically by the scanner.

FIG. 05 shows a variant in which the identification code, in the present case the number 0103, is manually input on the keypad of the mobile telephone, then sent by SMS by dialing a telephone number.

FIG. 06 shows the confirmation of the message received by the central facility. Furthermore (not illustrated in this figure), the message also indicates whether or not the user is authorized to rent the object.

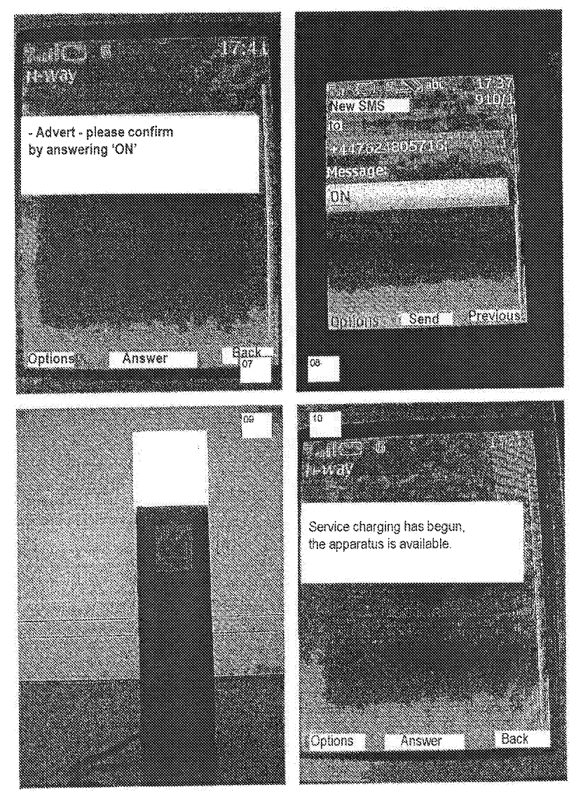

FIG. 07 shows the reception of a message inviting the user (if not already done automatically) to switch on the light. This message may or may not be associated with an inserted advertisement. Optionally (not illustrated in this figure), a request may be made for identification by means of a code.

FIG. 08 illustrates the sending by the user of a message to activate the apparatus to the central facility, the latter then relaying the message to the auxiliary element.

FIG. 09 shows the illuminated light; the auxiliary element informs the central facility that the light is operating.

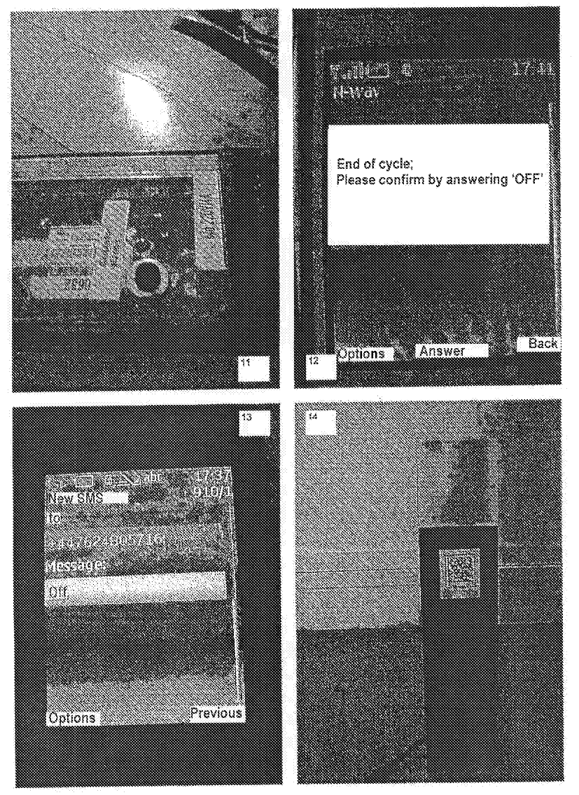

FIG. 10 depicts a message informing the user that the light is available. The timing and the charging for the time using the light are started from this moment. Advantageously, the user may be constantly informed of the time and of the total cost of the use of the light.

FIG. 11 illustrates a part of the auxiliary element that comprises a push-button that can be actuated by the user with the aim of terminating the use of the light.

For the light illustrated in this figure, but generally for the rentable object, the auxiliary element may comprise an on/off switch device that responds to a manual or other action, e.g. following the activation of a sensor.

If the rentable object has an operating cycle, e.g. it is a washing machine, an interruption device may be actuated when the machine has completed its washing cycle.

FIG. 12 shows a message in which the central facility informs the user of the end of the use cycle of the rentable object.

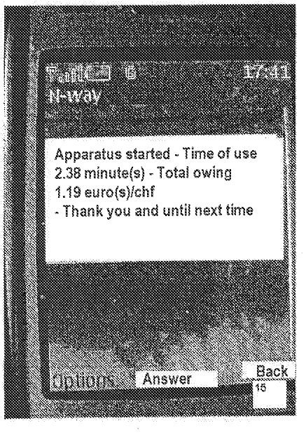

FIG. 13 shows confirmation by the user of the end of the rent period.

FIG. 14 shows the light that has just been switched off by the central facility via the auxiliary element.

FIG. 15 shows the end-of-use message, which summarizes the total duration of use of the light and the total cost billed for the rental.

It goes without saying that the example above may be used with other types of message, e.g. e-mail, audio or video.

### EXAMPLE 2

### Vehicle Rental

FIG. 16 schematically shows a rental vehicle, a user with a mobile telephone and a central facility.

The following references are used in FIG. 16:

A = User
L = location of the apparatus for collective use (C)
1 = communications case (connection between user and central facility)
id = manual or automatic input of the identification code situated on
the apparatus
B = Central facility
2 = transmitter-receiver (connection between user and the central
facility and between the central facility and the apparatus)
ge = system for managing the apparatus (identification of apparatus
and user, authorization, etc.)
s′/s″ = electromagnetic signal transmissions
C = Apparatus for collective use
3 = transmitter-receiver (connection between central facility
and the apparatus)
ky = unblocking/blocking system

The rentable vehicle has an identification code. This may be the license plate number of the vehicle or another number fixed visibly on the vehicle. The identification code may also be in the form of a bar code, or more generally in the form of a distinctive sign that can be recognized easily by a user.

The vehicle also comprises a blocking and unblocking system that can be remotely activated by the central facility.

The blocking or unblocking respectively is preferably blocking of the vehicle doors. Alternatively or additionally, the blocking/unblocking may be applied to the starting of the motor of the vehicle.

The blocking and/or unblocking is activated from the central facility by means of a wireless transmission, generally by radio waves, or by traditional wiring if the object is static.

In a first step, the user, who is close to a vehicle that he wishes to rent, sends an enquiry to the central facility by SMS using his mobile telephone. To do this, the identification code of the vehicle (e.g. license plate number) is entered into the telephone and transmitted to the central facility. Various ways may be used for inputting the identification code, e.g. manual input on the telephone keypad, automatic input if the identification code is a bar code and if the telephone is equipped with a bar-code reader, etc.

If the vehicle is free and if the user meets the conditions required to rent the vehicle (e.g. he has a customer account with the rental company, legal age), the central facility unblocks the vehicle remotely.

Once inside the vehicle, according to one variant, the user can immediately start the motor (e.g. by pressing a button).

According to another variant, which has the advantage of offering a better security level, the user must enter a password in order to be able to start the vehicle.

During its operation, the state of the vehicle (e.g. fuel gauge level) and the location of the vehicle (e.g. by means of a GPS system) are preferably communicated constantly or periodically to the central facility and/or to the user.

Once the use of the vehicle has finished, the user transmits a message to the central facility by means of his mobile telephone. Charging is then carried out, then the bill addressed to the user, or alternatively the customer account is debited. The central facility in return transmits a blocking signal to the vehicle.

According to a variant, the user sends an inquiry to the central facility in advance with his mobile telephone so as to determine the location of the nearest available vehicle. Once this information has been received, he goes to the vehicle and proceeds in the same way as previously described.

It is obvious that the invention is not limited to the use of SMS to ensure the communication between the user and the central facility. Any other suitable means such as MMS or spoken communication may be used.

According to a variant of the invention, during the first transmission to the central facility, one or more messages that are indicative, informative or have an advertising character are sent from the central facility back to the user terminal. These messages may be transmitted in a format that is static (writing), acoustic (sounds, music) or cinematic (video sequence, animation).

This message(s) may also be transmitted from the central facility to the user terminal at any time, or through the whole duration of the service (identification, sale, return of the vehicle, billing).

According to another variant, this message(s) is(are) not transmitted by the main central facility, but by a supplementary central facility on the command and indications of the main central facility.

(Sending of indications, respectively, of the coordinates of the user terminal to a supplementary provider.)

It is obvious that the invention is not limited to the two examples described above.

1. An automated rental system comprising:
a rentable object provided with an identification code;
an auxiliary element operationally connected with the rentable object and comprising an activation/deactivation system that can be remotely activated;
a portable device, such as a mobile telephone, comprising a wireless telecommunications interface; and
a central facility comprising means to ensure two-way communication with said auxiliary element and said portable device;
said central facility also comprising means for processing said identification code, means for acting on said activation/deactivation system, means for recording the length of use of the rentable object and means for managing accounts for individuals who use said rentable object.

2. The system as claimed in the preceding claim, characterized in that the portable device is a wireless telephone.

3. The system as claimed in claim 1 or 2, characterized in that the telecommunications interface authorizes the exchange of written messages such as SMSs with the central facility.

4. The system as claimed in any one of the preceding claims, comprising means for controlling the state of the rentable object.

5. The system as claimed in any one of the preceding claims, comprising means for locating the rentable object.

6. The system as claimed in the preceding claim, comprising means for indicating the location of the rentable object on the portable device.

7. The system as claimed in any one of the preceding claims, characterized in that the rentable object is a vehicle.

8. The system as claimed in any one of the preceding claims 1 to 6, characterized in that the rentable object is stationary, e.g. a light, and supplied with power by an electrical source, e.g. the electrical network.

9. The system as claimed in any one of the preceding claims, characterized in that the central facility comprises means for sending informative or advertising messages on a visual display system or a sound system located on the portable device.

10. The system as claimed in any one of the preceding claims, characterized in that it comprises automated means, such as a scanner, for inputting the identification code.

11. An automated rental method using a system as claimed in any one of the preceding claims, characterized by the following steps:
entering the identification code of the rentable object into the portable device;
transmission of the identification code to the central facility;
processing of the rental request by the central facility;
transmission of an activation signal to the auxiliary element; and
activation of the rentable object via the auxiliary element.

12. The rental method as claimed in the preceding claim, furthermore comprising the following steps:
transmission of data to the central facility relating to the operation and/or the location of the rentable object;
when the rental is finished, transmission to the central facility of a corresponding signal via the portable device or via the auxiliary element; and
deactivation of the rentable object via the auxiliary element.

13. The rental method as claimed in claim 11 or 12, characterized in that before the entering of the identification code of the object into the portable device a request is made to the central facility in order to determine the location of the rentable object.

14. The method as claimed in any one of the preceding claims 11 to 13, comprising a step during which the central facility sends at least one informative or advertising message to the portable device.
